(19) United States
(12) Patent Application Publication
(10) Pub. No.: US 2021/0133184 A1
(43) Pub. Date: May 6, 2021

(54) DATA SHARING METHOD THAT IMPLEMENTS DATA TAG TO IMPROVE DATA SHARING ON MULTI-COMPUTING-UNIT PLATFORM

(71) Applicant: Shi Wu LO, Changhua City (TW)

(72) Inventor: Shi Wu LO, Changhua City (TW)

(21) Appl. No.: 17/085,736

(22) Filed: Oct. 30, 2020

(30) Foreign Application Priority Data
Nov. 4, 2019 (CN) 201911067350.9

(51) Int. Cl. G06F 16/23

(52) U.S. Cl. CPC G06F 16/2379

(57) ABSTRACT

A data sharing method that implements data tag to improve data sharing on a multi-computing-unit platform, wherein the multi-computing unit platform includes multiple cores, and multiple threads generating multiple critical sections on each core. When a first thread enters a first critical section to access a shared data, the shared data is temporarily stored in a first core, when the first thread leaves the first critical section, it transfers the control of the shared data to a second core that has higher transmission advantage.

### CROSS-REFERENCE TO RELATED APPLICATIONS

This application claims the priority benefit of CN application serial No. 201911067350.9, filed on Nov. 4, 2019. The entirety of the above-mentioned patent application is hereby incorporated by reference herein and made a part of specification.

### BACKGROUND OF THE INVENTION

### 1. Field of the Invention

The present invention relates to a data sharing method, particularly to a data sharing method that implements data tag to improve data sharing on a multi-computing-unit platform.

### 2. Description of the Related Art

In a multi-core environment with shared memory, data is transmitted through a bus between cores. If the distance of transmission routing is long, then the transmission latency is also prolonged. In recent years, various kinds of high performance multi-core systems are developed, such as the Xeon™ processor brought out by Intel™ Corp. in 2017 that has 28 cores, and can be connected to upmost 8 processors. In such multi-core processor system, it is the efficiency of accessing and synchronizing the data in the memory that makes the bottleneck of the entire system.

In a Uniform Memory Access (UMA), the processors are connected to a single main memory, such that the access time to the data in the memory is irrelevant to which of the processors sent the access request. The issue of the UMA is that it is un-scalable. To address the issue of the UMA, a Non-Uniform Memory Access (NUMA) divides its processor into multiple nodes, and each node has its own main memory, and it is faster to access the local memory in its own node than accessing a faraway memory in another node.

In a cache coherent NUMA (ccNUMA) system, the concept of NUMA is implemented on an internal cache memory, where each core has a complete cache hierarchy, and the last level cache (LLC) of each core is connected by internal communication network. Since accessing a local cache memory is faster than accessing a remote cache memory, if the required data is located in the cache memory of another core of the same chip, then the latency is determined by the distance between the two cores because the required data has to be transmitted between the two cores.

Another factor that effects the processor performance is data synchronization. In a software system such as POSIX Pthread, a thread will set off data lock before accessing a shared data in order to ensure the correctness of a shared data. However, this will block other threads that also need access to the shared data since the shared data is locked by the previous thread that enters the critical section, and will significantly lower the parallelization of the threads. There are some technologies developed to address the issue, such as the 2019 version of GNU's POSIX spinlock (plock) for example. In plock, a thread will test the global lock variable continuously before entering the critical section. However, as known in the art, the scalability of plock is not good, and the order of executing is unfair. Although there are some methods brought up to improve the fairness, such as MCS and ticket lock, the fairness and efficiency issue is far more complicated in a multi-core processor system because of higher parallelization, and data transmission latency between cores.

### SUMMARY OF THE INVENTION

An objective of the present invention is to provide a data sharing method that implements data tag to improve data sharing on a multi-computing-unit platform utilizing data tag to improve data sharing efficiency and fairness. The platform includes multiple instances that declare intension to access the shared data. The data sharing method comprises the following steps:

tagging a start point and an end point of an access section for the shared data;

when a first instance of the multiple instances is allowed to access the shared data at the start point, limiting a plurality of second instances of the multiple instances to enter the access section and access the shared data;

when the first instance finishes accessing the shared data at the end point, giving a priority of accessing the shared data to one of the second instances that requires the least system resource.

Since the data sharing method of the present invention gives the priority to the next instance that declares intension to access the shared data according to the system resource required by each instance, a better schedule to shorten the “shared data” transfer path is generated, thereby ensuring the efficiency and fairness of the overall performance of the multi-threaded program.

Other objectives, advantages and novel features of the invention will become more apparent from the following detailed description when taken in conjunction with the accompanying drawings.

### BRIEF DESCRIPTION OF THE DRAWINGS

FIG. 1 is a flow chart of a data sharing method of a present invention.

FIG. 2 is a schematic block diagram of the algorithm coding of the present invention.

FIG. 3 is a schematic block diagram of a multi-core processor of the present invention.

FIG. 4 is a schematic diagram of the communication efficiency of the v-cores in the multi-core processor.

FIG. 5 is an algorithm coding of a first embodiment of the present invention.

FIG. 6 is a schematic block diagram of multiple critical sections 104 of the present invention.

FIGS. 7A-7G are schematic diagrams of multiple mapping of optimized routing.

FIG. 8 is another schematic diagram of the communication efficiency of the v-cores in the multi-core processor.

FIG. 9 is an algorithm coding of a second embodiment of the present invention.

FIG. 10 is a schematic block diagram of multiple threads in one v-core of a third embodiment of the present invention.

FIG. 11 is an algorithm coding of the third embodiment of the present invention.

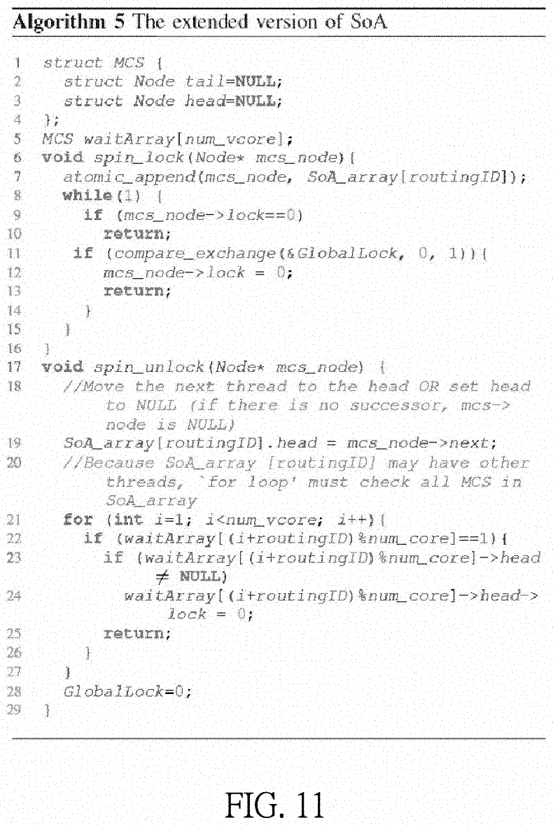

### DETAILED DESCRIPTION OF THE INVENTION

The present application provides a data sharing method utilizing data tag performed by a multi-computing unit platform, which lowers the cost of data transmission between cores, and improves the fairness of the orders to access shared data of the instances.

The platform includes multiple instances that declare intension to access the shared data, and each instance requires a system resource while accessing the shared data.

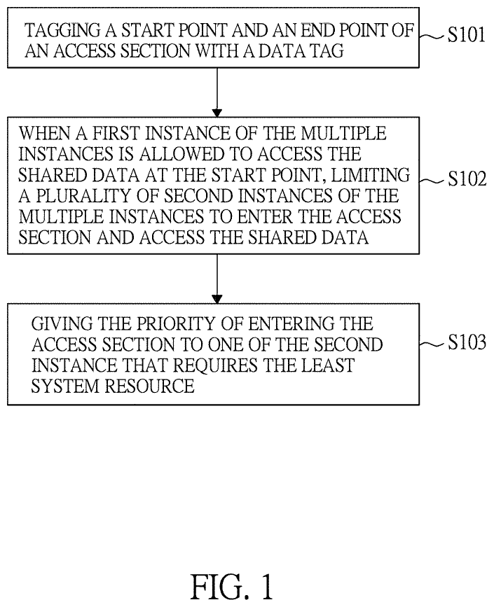

With reference to FIG. 1, the data sharing method comprises the following steps:

tagging a start point and an end point of an access section for the shared data with a data tag(S101);

when a first instance of the multiple instances is allowed to access the shared data at the start point, limiting a plurality of second instances of the multiple instances that are waiting to enter the access section to access the shared data (S102); wherein the second instances are other instances except for the first instance in the multiple instances; and

when the first instance finishes accessing the shared data at the end point, giving the priority of accessing the shared data to one of the second instances that requires the least system resource (S103).

The platform is a multi-computing-unit platform, such as a multi-core processor. Each of the instances may by a process, a thread, a processor, a core, a virtual core (VC), a piece of code, a hardware or a firmware that can access the shared data.

At the start point of the access section, the platform will mark every instance that declares intension to access the shared data, and calculate an optimized order of the instances according to the required system resource of each instance in advance. At the end point of the access section, the platform will decide which of the other instances can enter the access section. That is, when a first instance leaves the access section, the platform gives the next instance in the cyclic order the priority to enter the access section.

There are many different methods available to ensure the consistency of the shared data. For example, the data tag may be a critical section, roll back mechanism, read-copy-update (RCU) mechanism, spinlock, semaphore, mutex, or condition variable. The main concern of the present invention is not the consistency of the shared data, but the mechanism to decide the next instance allowed to access the shared data.

To make our method understandable, we will explain the data tag of the access section with the embodiment of critical section 104, which may be spinlock, semaphore, or mutex, and provide a full understanding of the method of determining the next instance to access the shared data.

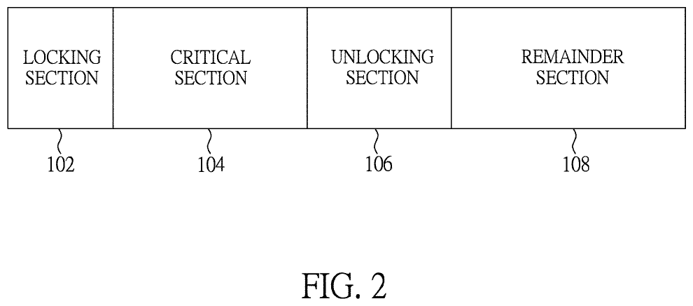

With reference to FIG. 2, the coding of a lock may include a locking section 102, a critical section 104, an unlocking section 106 and a remainder section 108. The critical section 104 is where an instance accesses the shared data, and the locking section 102 ahead of the critical section 104 ensures the consistency of the shared data and only one instance can access the shared data at the same time. At the end of the critical section 104 where the instance finishes accessing the shared data, the instance will enter the unlocking section 106 to unlock the shared data. In the present embodiment, the locking section 102 and the unlocking section 106 are the data tags that mark the access section of the invention. The data tags ensure the mutual exclusive instances will be executed one by one in the cyclic order, therefore, when an instance currently in the critical section 104 leaves the critical section 104, the next instance in the cyclic order that declares the intension to enter the critical section 104 may enter. In another embodiment, if the instances are not mutually exclusive, namely, the instances are parallelizable interval (i.e., non-exclusive access), they may enter the access section (critical section 104) at the same time. To be more specific, when an instance currently in the critical section 104 leaves the critical section 104, the multiple instances that are not mutually exclusive and have higher priority in the cyclic order, that is, the priority higher than the instance which needs exclusive access, or the multiple instances that are not mutually exclusive and have low system resource may enter the access section (critical section 104) at the same time.

It should be noticed that the platform must ensure that “the mutually exclusive execution of instances which needs exclusive access” remains unchanged.

The cyclic order of the instances may be determined according to the consumed power, accessing time, acquired bandwidth when accessing the shared data, or the ability to parallelize.

In an embodiment, when an instance leaves the critical section 104, the instance lets the instance which is waiting in the lock section and needs minimal resources to enter the critical section (e.g., according to the cyclic order).

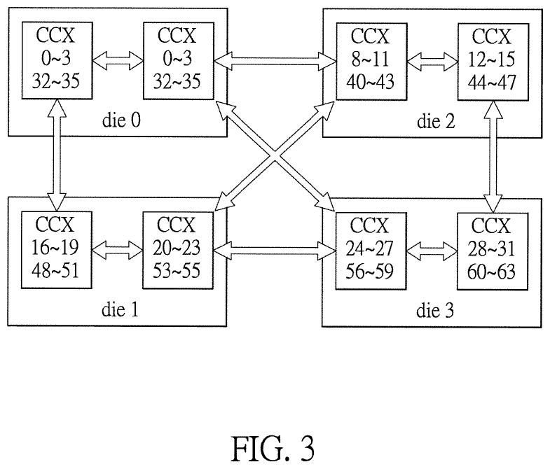

To simplify the explanation below, in a first embodiment of the present invention, we assume that each thread has only one critical section 104. With reference to FIG. 3, an architecture of an AMD Threadripper 3990WX processor (Threadripper processor) is shown. A Threadripper processor contains 4 dies, which are die0˜die3; each die contains 2 CPU compleXs (CCX), and each CCX contains 8 v-cores. The numbers in each CCX block represent the serial number of each v-core. Wherein inside a CCX the v-cores are connected by level 3 cache memory, the two CCXs on the same die are connected by high-speed network, and the dies on the same processor are connected with a middle-speed network.

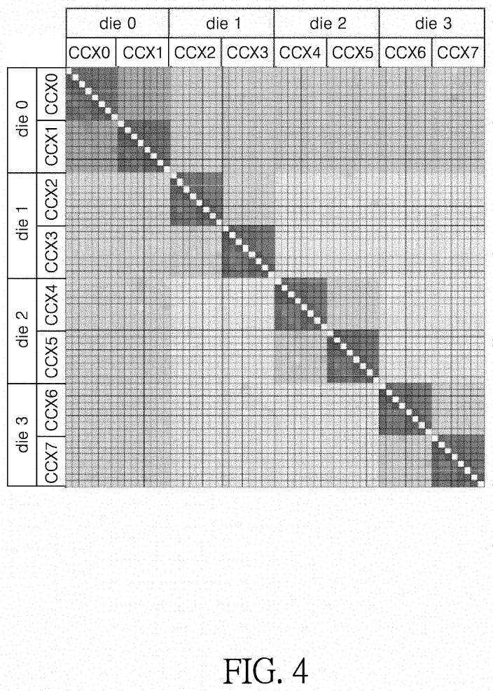

With reference to FIG.4, the horizontal axis and the vertical axis are the 64 v-cores in a Threadripper processor, and each coordinate point (x,y) represents the communication efficiency between v-core x and v-core y. The order of the v-cores in FIG.4 is based on the physical position, not the serial number of the v-cores. Darker colors indicate lower switching overheads. For example, when both v-core x and v-core y are in CCX0, the color is darker, which means lower communication cost. When v-core x is in CCX0 and v-core y is in CCX1, the color is darker, which means higher communication cost.

According to the communication efficiency diagram in FIG.4 and using an optimization tool such as Google's OR Tools, an optimized order may be as follows: {0,1,2,3,32,33,34,35,4,5,6,7,36,37,38,39,8,9,10,11,40,41,42,43,12,13, 14,15,44,45,46,47,24,25,26,27,56,57,58,59,28,29,30,31,60,61,62,63,16,17,18,19,48,4 9,50,51,20,21,22,23,52,53,54,55}, which may be the cyclic order of the instances to access the shared data. In the optimized order, each number represents serial number of a v-core. The optimized order array stated above may be further converted into a routing ID of each core as follows: {0, 1, 2, 3, 8, 9, 10, 11, 16, 17, 18, 19, 24, 25, 26, 27, 48, 49, 50, 51, 56, 57, 58, 59, 32, 33, 34, 35, 40, 41, 42, 43, 4, 5, 6, 7, 12, 13, 14, 15, 20, 21, 22, 23, 28, 29, 30, 31, 52, 53, 54, 55, 60, 61, 62, 63, 36, 37, 38, 39, 44, 45, 46, 47}. For example, according to the routing ID array, v-core number 9 (core 9) is the 18^{th} in the optimized order array; therefore, its routing ID (routingID) is idCov[9]=17.

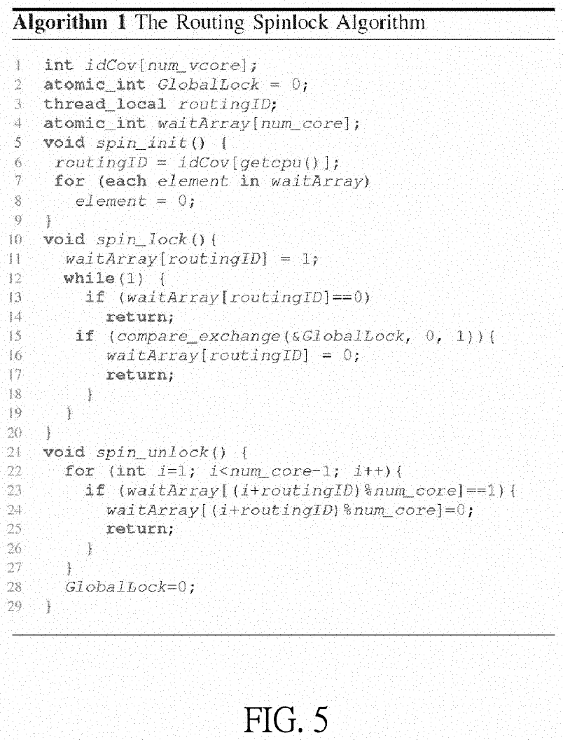

FIG. 5 shows an algorithm of the procedure of the present invention. The generating of the variables routingID and idCov is stated above. The variable GlobalLock is set to 0 when no instance is in the critical section 104. The instance herein may be a virtual core (v-core) that declares intension to enter the critical section 104, and the v-core has at most one thread on it. If the number of threads exceeds 64, a lock-free linked list can be implemented to realize the present invention. In the present embodiment, the platform sets up a waiting queue, when an instance wants to enter a critical section 104, its waitArray[routingID] is set to 1. When a first instance that is currently in the critical section 104 is leaving, or the platform is allowing another instance to enter the critical section 104, it searches for the next instance in the waiting Array that has a waitArray[routingID]=1 and allows it to enter the critical section 104. The size of the waitArray equals to the number of the v-cores. When the thread on v-core number K (v-core K) wants to enter the critical section 104, the thread will set waitArray[K] to 1. When the thread former to the v-core K in the waiting array that is currently in the critical section 104 (former thread) leaves, the former thread sets waitArray[K] to 0.

In spin_init( ), all the variables above are set to 0, and the routingID is set in accordance with the serial number of the v-core at which the present thread is with get_cpu( ) through idCov[ ] to get the sequence number of the thread in the optimized order.

In spin_lock( ), the thread sets waitArray[routingID] to 1 and declares that it wants to enter the critical section 104, and enters the loop in coding ln. 12˜18 in FIG. 4. Coding ln. 12˜18 is a waiting loop, wherein the thread can only enter the critical section 104 when waitArray[routingID] is set to 0, or GlobalLock is set to 0 and compare_exchange is true.

In spin_unlock, when the present thread is leaving the critical section 104, it picks out the next thread that can enter the critical section 104 in the optimized order, which is effective with the variable routingID and idCov[ ]. Therefore, in coding ln. 22-27, the thread searches one by one for the next thread with waitArray[]=1, which is the next thread in the optimized order that wants to enter the critical section 104. Then, the present thread sets the waitArray[ ] of the next thread to 0, such that the next thread can enter the critical section 104. Finally, when no thread in the waitArray wants to enter the critical section 104, GlobalLock is set to 0.

The method described in FIG.5 should be implemented with appropriate atomic operation, such as atomic_load( ), atomic_store( ), atomic_compare_exchange( ). Those functions are standard protocol in C language, for instance, C11 standard language. Therefore, detailed description is omitted hereinafter and a person with common knowledge in the art should have no difficulty in realizing such implementation.

In a second embodiment of the present invention, a lock-free linked list is implemented in spin_lock( ). An additional search mechanism is added to choose an entering point. Since the linked list is sequenced in spin_lock( ), it can simply set the waiting array variable of the next thread to be 0 in spin_unlock( ).

In an embodiment, the thread currently in the critical section 104 and the next thread in the optimized order which intends to access different shared data. For example, the critical section 104 is designed to protect a shared data that is in “linked list” form. In such circumstance, each element in the list may include the serial number (e.g., thread ID, process ID) of its corresponding thread, and when the thread leaves the critical section 104, the thread looks for the next thread in the optimized order according to the serial number of the element.

In an embodiment, the optimized order can be an ordered list (i.e., circular list, array). The platform determines which instance has the highest processing efficiency by searching for the instance to enter the critical section 104 according to the ordered list.

Furthermore, if the shared data has a container-type data structure, for example queue or a stack data structure, and the queue or stack also includes a data element that records the thread, or CPU, that pushes the data into the queue or stack. When the element is popped out from the queue or stack by the latest thread or CPU that makes access, the thread or CPU that is closest to the thread or CPU that pushes the data is allowed to enter the critical section 104.

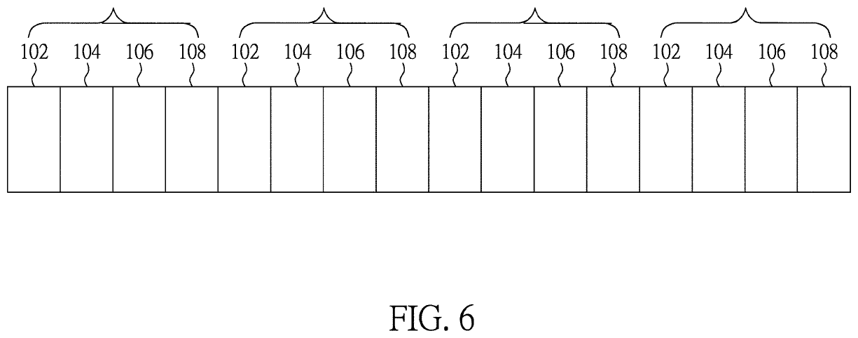

With reference to FIG.6, when there are multiple critical sections 104, for example, 4 critical sections 104, in the system, they may share the same idCov. When all critical sections share the same idCov, the order and priority of entities which want to enter critical sections are the same.

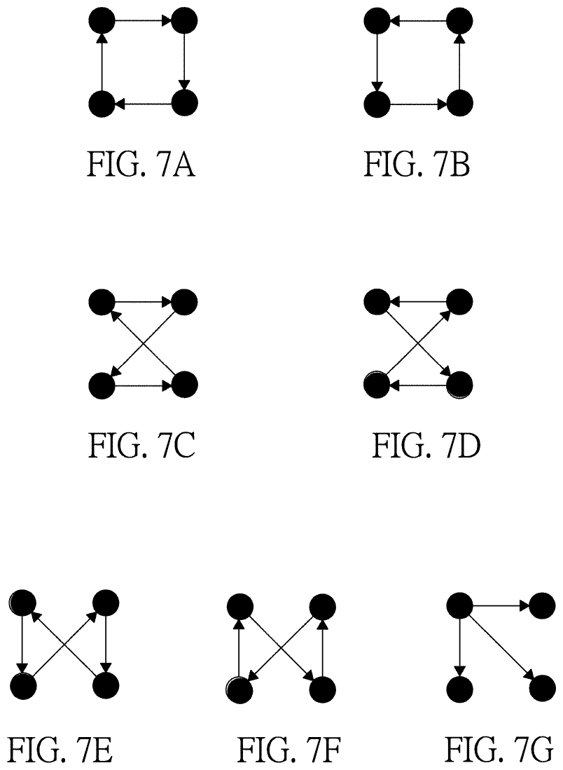

With reference to FIG.7, a schematic diagram of mapping out multiple idCov is shown. FIG.7 shows 7 possible different routings. Each black spot in FIG. 7 represents a die in Threadripper processor. Since the dies in Threadripper processor are fully connected, the optimized routes (1)˜(6) are generated. Furthermore, according to FIG. 3, die 0 has the best communication efficiency to the other dies (die1˜die3), and therefore the optimized route (7) is generated. For example, we list the optimized order and the corresponding waiting array below.

For route (1) the optimized order is {0, 1, 2, 3, 32, 33, 34, 35, 4, 5, 6, 7, 36, 37, 38, 39, 8, 9, 10, 11, 40, 41, 42, 43, 12, 13, 14, 15, 44, 45, 46, 47, 24, 25, 26, 27, 56, 57, 58, 59, 28, 29, 30, 31, 60, 61, 62, 63, 16, 17, 18, 19, 48, 49, 50, 51, 20, 21, 22, 23, 52, 53, 54, 55}, and the corresponding routing ID (idCov) is

{0, 1, 2, 3, 8, 9, 10, 11, 16, 17, 18, 19, 24, 25, 26, 27, 48, 49, 50, 51, 56, 57, 58, 59, 32, 33, 34, 35, 40, 41, 42, 43, 4, 5, 6, 7, 12, 13, 14, 15, 20, 21, 22, 23, 28, 29, 30, 31, 52, 53, 54, 55, 60, 61, 62, 63, 36, 37, 38, 39, 44, 45, 46, 47, 8, 9, 10, 11}

For route (2) the optimized order is {4,5,6,7,36,37,38,39,0,1,2,3,32,33,34,35,12,13,14,15,44,45,46,47,8,9,10,11,40,41,42, 43,28,29,30,31,60,61,62,63,24,25,26,27,56,57,58,59,20,21,22,23,52,53,54,55,16,17,1 8,19,48,49,50,51}, and the corresponding routing ID (idCov) is

{0, 1, 2, 3, 24, 25, 26, 27, 16, 17, 18, 19, 56, 57, 58, 59, 48, 49, 50, 51, 40, 41, 42, 43, 32, 33, 34, 35, 12, 13, 14, 15, 4, 5, 6, 7, 28, 29, 30, 31, 20, 21, 22, 23, 60, 61, 62, 63, 52, 53, 54, 55, 44, 45, 46, 47, 36, 37, 38, 39}

For route (3) the optimized order is {0,1,2,3,32,33,34,35,4,5,6,7,36,37,38,39,16,17,18,19,48,49,50,51,20,21,22,23,52,53,5 4,55,24,25,26,27,56,57,58,59,28,29,30,31,60,61,62,63,8,9,10,11,40,41,42,43,12,13,14,15,44,45,46,47}, and the corresponding routing ID (idCov) is

{0, 1, 2, 3, 8, 9, 10, 11, 48, 49, 50, 51, 56, 57, 58, 59, 16, 17, 18, 19, 24, 25, 26, 27, 32, 33, 34, 35, 40, 41, 42, 43, 4, 5, 6, 7, 12, 13, 14, 15, 52, 53, 54, 55, 60, 61, 62, 63, 20, 21, 22, 23, 28, 29, 30, 31, 36, 37, 38, 39, 44, 45, 46, 47}

In the system, for each critical section 104, there can be a different optimized order, or routing ID (idCov). A certain optimized order may be determined by the condition of the route (bandwidth of each path, latency, mutual effect), or by the condition of the critical section 104 (loading of data to be transmitted, requirement of transmitting speed). In another embodiment, a critical section 104 may implement a different optimized order to reach loading balance.

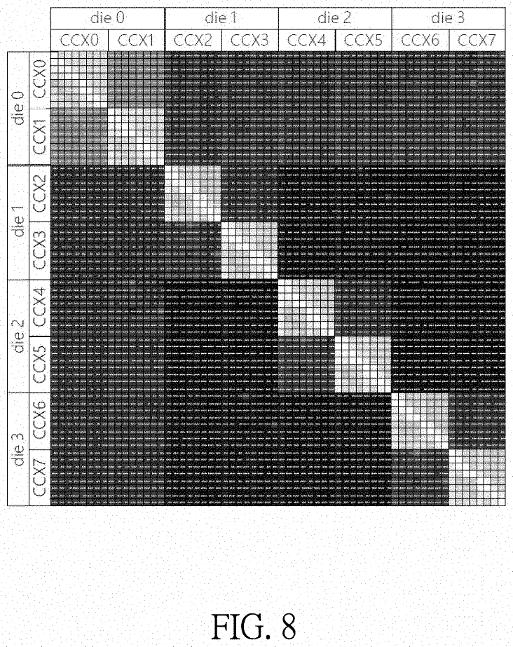

With reference to FIG. 8, which is a schematic diagram of the communication time between each pair of the 64 v-cores, the lighter the color means the shorter the communication time. In an embodiment, when determining the next thread to enter the critical section 104, the system selects the thread corresponding to the lighter color.

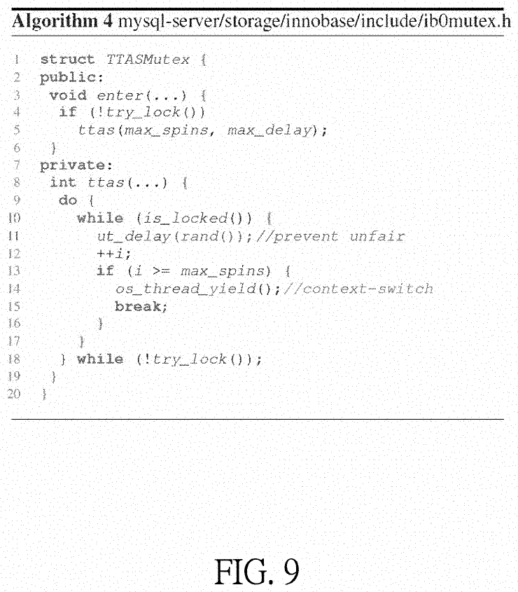

With reference to FIG.9, in a third embodiment of the present invention, the implementation of the present invention in an Oracle MySQL is explained. In the present embodiment, row lock may be used in Oracle MySQL instead of table lock, therefore making MySQL more efficient on multiple cores. When spinlock is too long, os_thread_yield( ) is used in ln. 13 to trigger a context-switch. On ln. 11, randomly wait for a short period. This can avoid the constant execution of the costly instruction compare_exchange( ). Through rand( ), it can avoid that the lock is always handed to the neighboring thread on the same core.

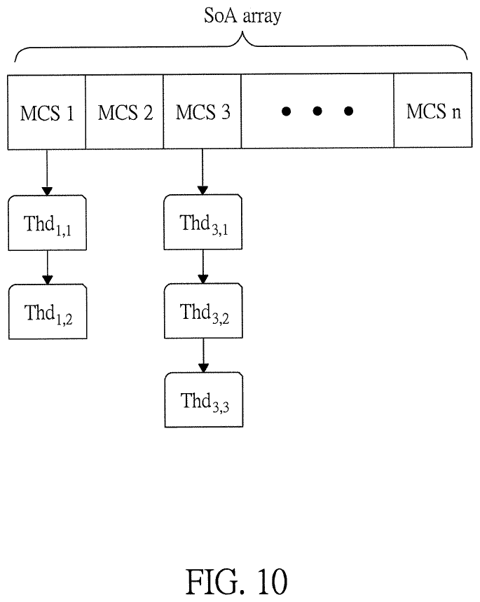

In a fourth embodiment of the present invention, it is assumed that there may be more than one thread on a v-core. With reference to FIGS. 9 and 10, in the present embodiment, the algorithm of the first embodiment is combined with a MCS spinlock algorithm, and the data type of each element in the SoA_array is MCS, defined in ln. 1-4 of the code. In ln. 5, an MCS waitarray is defined.

In spin_lock( ), the mcs node is added to SoA_array[routingID] in ln. 7. Then in the loop in ln. 8˜14, it waits for the lock holder to set GlobalLock or mcs_node→lock to 0, to enter the critical section 104.

In spin_unlock( ), firstly, the next mcs_node is moved to the first of the “MCS element” of SoA_array, therefore the next thread may be moved to the head and be executed. If there is no successor thread in the MCS node, then the mcs_node is NULL. The loop in ln. 21-27 searches for the next thread to enter the critical section 104 in the order of routingID (line 21-27). If no thread wants to enter the critical section 104, set GlobalLock to 0.

In a fifth embodiment of the present invention, the system calculates and stores a table that records the transmission cost between multiple cores. The value of the transmission cost may be a real number between 0 and 1. In the step of giving the priority of accessing shared data to one of the second instances that requires the least system resource, the least system resource required by the instances is determined by looking up the table and determining the second instance that has the least transmission cost. That is, when an instance leaves the critical section and enters the unlock section, the next instance with the least transmission cost is allowed to enter the critical section.

In the embodiment, the required system resource, that is, the transmission cost, is listed between 0 and 1, rather than an indication of only “0” or “1”. Therefore the order of the instances is classified in a more detailed degree and the data accessing is further optimized.

Furthermore, the platform calculates a cyclic order of the instances when accessing shared data according to the transmission costs between multiple cores. Wherein the step of giving the priority of accessing shared data to one of the second instances that requires the least system resource, the priority is given to the second instance with a closest cyclic order that is smaller than the cyclic order of the first instance that leaves the critical section.

In this embodiment, an instance can appear multiple times in the order.

In the embodiment, when the second instance is waiting to access the shared data, the second instance is inserted into a waiting list to enter the access section according to the cyclic order. In another embodiment, when the first instance leaves the critical section, the instance with the lowest cost is selected.

In yet another embodiment, the instances may be excluded by certain conditions. For example, the instances may be excluded according to the numbering of the core in which the instance is located. If the core number of the instance that awaits to enter the critical section is smaller than the core number of the last instance that leaves the critical section, the instance that awaits is excluded. This further ensures the bounded-waiting and fairness.

In conclusion, the present invention of data sharing method implementing data tag performed by a multi-computing unit platform provides the procedure of deciding the next instance to access the shared data. The embodiments provide detailed algorithms and methods to generate an optimized order of the instances according to the communication time. A person having ordinary skill in the computer technology can choose another factor, for example, power consumption or ability of parallelization, as the base of optimization computing.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A data sharing method implementing a data tag performed by a multi-computing unit platform, wherein the platform includes multiple instances that declare intension to access shared data, and each instance requires a system resource while accessing the shared data; the data sharing method comprises the following steps:
tagging a start point and an end point of an access section for the shared data with a data tag;
when a first instance of the multiple instances is allowed to access the shared data at the start point, limiting a plurality of second instances of the multiple instances that are waiting to access the shared data to enter the access section; and
when the first instance finishes accessing the shared data at the end point, giving a priority of accessing the shared data to one of the second instances that requires the least system resource.

2. The data sharing method as claimed in claim 1, wherein the instances are processes, threads, processors, cores, virtual cores, pieces of codes, hardware, or firmware accessing the shared data.

3. The data sharing method as claimed in claim 1, wherein the platform calculates a cyclic order of the instances when accessing the shared data;
wherein the cyclic order is determined according to the system resource that each instance requires.

4. The data sharing method as claimed in claim 1, wherein at the start point of the access section, each instance declares the intension to enter the access section to access the shared data, and
wherein at the end point of the access section, each instance decides the next instance to enter the access section.

5. The data sharing method as claimed in claim 3, wherein at the start point of the access section, the instances declare the intension to enter the access section to access the shared data, and
wherein at the start point of the access section, each instance inserts itself to a list based on the cyclic order which is determined according to the required system resource of each instance.

6. The data sharing method as claimed in claim 1, wherein the platform calculates a cyclic order according to a system resource consumption of any two of the instances in advance;
wherein when the first instance leaves the access section, the next instance in the cyclic order is allowed to enter the access section.

7. The data sharing method as claimed in claim 1, wherein the data tag is a critical section, roll back mechanism, read-copy-update (RCU) mechanism, spinlock, semaphore, mutex, or condition variable.

8. The data sharing method as claimed in claim 1, wherein when the first instance finishes accessing the shared data, the multiple second instances are allowed to enter the access section; and
wherein the multiple second instances are not mutually exclusive and have low source consumption requirement.

9. The data sharing method according to claim 8, wherein the plurality of instances that access the shared data at the same time are the instances having a higher cyclic order than a next exclusive instance.

10. The data sharing method as claimed in claim 1, wherein when the first instance finishes accessing the shared data, the multiple second instances are allowed to enter the access section;
wherein the multiple second instances are not mutually exclusive and require low system resource;
wherein at the same time the platform ensures the executing order of the mutually exclusive second instances remains unchanged.

11. The data sharing method as claimed in claim 1, wherein the platform sets up a cyclic order to schedule the multiple instances to enter the access section according to the cyclic order.

12. The data sharing method as claimed in claim 11, wherein the platform sets up a waiting array, and each instance that declares to access the shared data sets a waiting element in the waiting array to “1” according to the cyclic order;
wherein when the first instance finishes accessing the shared data and is leaving the access section, or when the platform is allowing another second instance to enter the access section, the platform searches for the next waiting element that is “1” in the cyclic order, and allows the corresponding second instance to enter the access section.

13. The data sharing method as claimed in claim 12, wherein the waiting array is generated as an array structure or a linked list structure.

14. The data sharing method as claimed in claim 1, wherein the condition of the system resource is selected according to an optimization objective of the platform.

15. The data sharing method as claimed in claim 1, wherein the data type of the shared data is a set, and the shared data to be accessed is one element in the set.

16. The data sharing method as claimed in claim 1, wherein the platform stores a table that records the transmission cost between multiple cores; wherein in the step of giving the priority of accessing shared data to one of the second instances that requires the least system resource, the least system resource required is determined by looking up the table and determining the second instance that has the lowest transmission cost.

17. The data sharing method as claimed in claim 1, wherein the platform calculates a cyclic order of the instances when accessing the shared data according to the transmission costs between multiple cores; wherein the step of giving the priority of accessing shared data to one of the second instances that requires the least system resource, the priority is given to the second instance with a closest cyclic order that is smaller than the cyclic order of the first instance.

18. The data sharing method as claimed in claim 17, wherein when the second instance is waiting to access the shared data, the second instance is inserted into a waiting list to enter the access section according to the cyclic order.

19. The data sharing method as claimed in claim 17, wherein when the first instance is leaving the access section, the first instance selects one of the second instances to enter the access section according to the cyclic order.
